(19) United States
(12) Patent Application Publication
(10) Pub. No.: US 2006/0153427 A1
(43) Pub. Date: Jul. 13, 2006

(54) Image methods for determining contour of terrain

(76) Inventors: Peter John Zanzucchi, Mercer, NJ (US); Herschel Clement Burstyn, Lawrenceville, NJ (US)

Correspondence Address: SWIDLER BERLIN LLP, 3000 K STREET, NW, BOX IP, WASHINGTON, DC, 20007, US

(21) Appl. No.: 11/033,550

(22) Filed: Jan. 12, 2005

(51) Int. Cl. G06K 9/00

(52) U.S. Cl. 382/113; 382/106; 382/108

(57) ABSTRACT

A device determines the contour of a landscape by receiving an optical image having a grid pattern projected thereon and converting the optical image of the landscape and the grid pattern into a digital image. The device employs software to perform an analysis of the color digital image to detect the grid pattern by using color characteristics of the mapping grid for processing the distortions of the grid pattern based on the Hausler and Heckel principles. An image is presented in real time to the viewer showing the depth pattern of the landscape in the image. This presentation may be by various colors, by outlines of constant depth and alike means commonly used in visual displays.

### BACKGROUND OF THE INVENTION

1. Field of the Invention

The present invention relates to a method, a system and a computer program product for determining the contour of a landscape. More particularly, the present invention relates to a method, a device and a computer program product for determining the contour of landscape based on distortion in a grid pattern in an image of the landscape.

2. Description of the Prior Art

There are many fields of industry where determining the contour of a landscape would be advantageous. One such circumstance occurs during the playing of the sport of golf. Typically, the sport of golf is played on terrain having a variety of characteristics including inclinations and slopes. A player's evaluation of the landscape of a golf course has an influence on their approach to strokes such as on the putting green. Some, techniques to evaluate the contour of a landscape use a single photograph. However, these techniques depend on overhead views in order to use geometric principles. Other techniques to evaluate the contour of a landscape use image parallax where a stereoscopic pair of images is used. The apparent change in position of image's elements in the pair of images is useful in determining information on their positional relation. However, these techniques are difficult for an individual to use, particularly if immediate action is needed in relation to the viewing of terrain topology. Other techniques to evaluate the contour of a landscape use a mapping grid where a laser creates a bright grid pattern that is overlaid onto the landscape. Height or depth can be determined based on the distortions in the grid pattern. These techniques are also difficult for an individual to use who is not specialized in the technique and do not produce immediate results. In addition, these techniques employ elaborate equipment that is not easily portable from place to place and takes substantial time to set up.

Accordingly, there is a need for a device that determines the contour of a landscape. There is further need for the device to be handheld. There is a further need for the device to operate in real time. There is a need for the device to operate independently of the view of the landscape. There is a need for the device to decrease the amount of time required to determine the contour of the landscape. There is a need for the device to find application in the sport of golf.

### SUMMARY OF THE INVENTION

According to embodiments of the present invention, a method, a device and a computer program product for determining the contour of a landscape based on distortion in a grid pattern in an image of the landscape are provided. The method includes projecting a mapping grid pattern onto a landscape, generating a digital image of the landscape with the mapping grid pattern, determining the contour of the landscape defined by the deformation of the mapping grid pattern in the digital image of the landscape and reporting a depth pattern of the landscape in the digital image. Determining the contour of the landscape includes reading the digital image for pixels having a target color space and determining the distance to a point on the mapping grid pattern.

In an embodiment of the present invention, the digital image is generated by a CMOS imager or a CCD imager. The imager provides a light source for generating the mapping grid pattern. The light source can transmit light through a mask that allows the light to pass in long linear segments over the landscape. The light source can operate at wavelengths in the near infrared.

### BRIEF DESCRIPTION OF THE DRAWINGS

The above described features and advantages of the present invention will be more fully appreciated with reference to the detailed description and appended figures in which:

FIG. 1 depicts an exemplary functional block diagram of a device in which the present invention can find application; and

FIG. 2 depicts an exemplary flow diagram for determining the contour of a landscape based on distortion in a mapping grid pattern in an image of the landscape according to an embodiment of the present invention.

### DETAILED DESCRIPTION OF THE INVENTION

The present invention is now described more fully hereinafter with reference to the accompanying drawings that show embodiments of the present invention. The present invention, however, may be embodied in many different forms and should not be construed as limited to embodiments set forth herein. Appropriately, these embodiments are provided so that this disclosure will be thorough and complete, and will fully convey the scope of the present invention.

According to embodiments of the present invention, a method, an image taking device and a computer program product for determining the contour of a landscape based on distortion in a mapping grid pattern in an image of the landscape where the mapping grid pattern is projected thereon are provided.

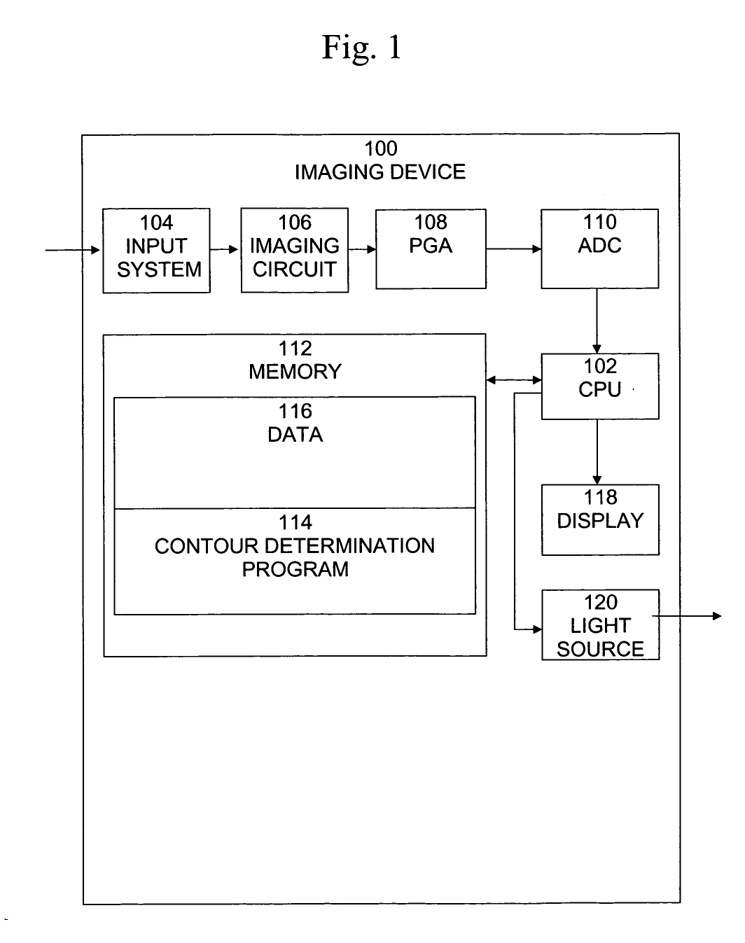

FIG. 1 depicts a functional block diagram of an image taking device in which the present invention can find application. In the embodiment of FIG. 1, image taking device 100 can be implemented to determine the contour of a landscape based on distortion in a mapping grid pattern in an image of the landscape onto which the mapping grid pattern was projected. In the FIG. 1 embodiment, image taking device 100 is a system, such as a digital camera, charge couple device (CCD) imager, complementary metal oxide semiconductor (CMOS) imager or the like, but can be any apparatus that executes program instruction in accordance with the present invention. In an embodiment of the present invention, the image taking device 100 is hand-held.

In the FIG. 1. embodiment of the present invention, the image taking device 100 includes a processor (CPU) 102, an input system 104, imaging circuitry 106, programmable gain amplifier (PGA) 108, analog-to-converter 110, memory 112, data 116, display 118, and grid pattern illumination source 120. In the FIG. 1 embodiment, the input system 104 is a digital image system. The input system 104 provides an interface for acquiring landscape light, light depicting a landscape, or mapping grid pattern reflected from a landscape and forming an image of the landscape light, light depicting the object, or mapping grid pattern reflected from the landscape. The input system 104 includes imaging optics and a charge-coupled device sensor having a plurality of pixels.

In the FIG. 1 embodiment of the present invention, the grid pattern illumination source 120 generates a mapping grid pattern using a light that is projected and overlaid onto an object. The light is selected from coherent or incoherent sources including, but not limited, to LEDs and lasers. In an embodiment of the present invention, the mapping grip pattern is generated based on the Hausler and Heckel principles. In an embodiment of the present invention, the grid pattern illumination source 120 can be an infrared LED diode lamp. In an embodiment of the present invention, the infrared LED diode lamp operates at a near infrared, but can operate at any wavelength where a detector sensors can identify the light but the light cannot be seen by the human eye. In an embodiment of the present invention, the LED diode lamp operates at a wavelength of approximately 780 nm.

In an embodiment of the present invention, the grid pattern illumination source 120 generates the mapping grid pattern by using a mask that allows light to pass in long linear segments in order to achieve the equivalent of a raster scan. The output from the mask is a series of equally spaced lines when viewed on a flat landscape at normal incidence. In an embodiment of the present invention, the grid pattern illumination source 120 generates the mapping grid pattern using software to perform a raster scan over the landscape. In an embodiment of the present invention, the mapping grip pattern illumination source 120 generates the mapping grip pattern from different perspective views. The generation of a mapping grid pattern for different perspective view can be performed using a lens that projects the pattern at different angles. In the FIG. 1 embodiment of the present invention, the grid pattern illumination source 120 is included in the image taking device 100. In an embodiment of the present invention, the grid pattern illumination source 120 is separate from the image taking device 100.

In the FIG. 1 embodiment of the present invention, the image taking device 100 projects the mapping grip pattern at an angle. In an embodiment of the present invention, a mapping grid pattern projected at an angle is formed as lines with unequal spacing due to the angle. Evaluation of the distorted mapping grid pattern can be performed to determine the angle of viewing and the contour of the object. In an embodiment of the present invention, a mapping grip pattern projected at an angle is formed with lines of equal spacing where the image taking device 100 alters the mapping grid pattern to compensate for the angle, such as by tilting. The tilting of the mapping grid pattern can be controlled manually or by software using information on line spacing. Visual evaluation of the distorted mapping grid pattern will give empirical information on the landscape contour without the variability of the unequal line spacing.

The input system 104 is coupled to circuitry 106 and provides an analog image signal to the circuitry 106. The circuitry 106 samples the analog image signal and extracts the voltage that is proportional to the amount of light which fell on each pixel of the charge-coupled device sensor of the input system 104. In embodiment of the present invention color components R (red), G (green) and B (blue) are used. In embodiment of the present invention, black and white are used. Programmable gain amplifier (PGA) 108 is coupled to circuitry 106, amplifies the voltages to the proper range and provides the voltages as input to analog-to-digital converter 110.

In this embodiment, the input system 104 is coupled to circuitry 106 and provide a suitable digital signal to CPU 102.

Analog-to-digital converter (ADC) 110 is coupled to CPU 102 and converts the voltage to a digital code suitable for further digital signal processing by CPU 102. The CPU 102 is a microprocessor, such as an INTEL PENTIUM® or AMD® processor, but can be any processor that executes program instructions in order to carry out the functions of the present invention. The CPU 102 calculates depth and angles based on the distortion of mapping grid pattern overlaid onto a landscape in an image of the landscape with the mapping grid pattern overlaid thereon in accordance with the principles of Hausler and Heckler.

In the FIG. 1 embodiment, the memory 112 is coupled to CPU 102 and stores landscape contour determination program 114 and data 116. The data 116 includes, but is not limited to, digital images depicting a landscape with a mapping grid pattern projected thereon and the color space of one or more pixels of the digital image. In an embodiment of the present invention, the digital image is in black and white. In an embodiment of the present invention, the digital image is in color.

In the FIG. 1 embodiment, the landscape contour determination program 114 provides the functionality associated with determining the contour of a landscape as executed by the CPU 102. The landscape contour determination program 114 is designed to report detection of the mapping grid pattern projected onto a landscape in the color digital image, such as on a display 118.

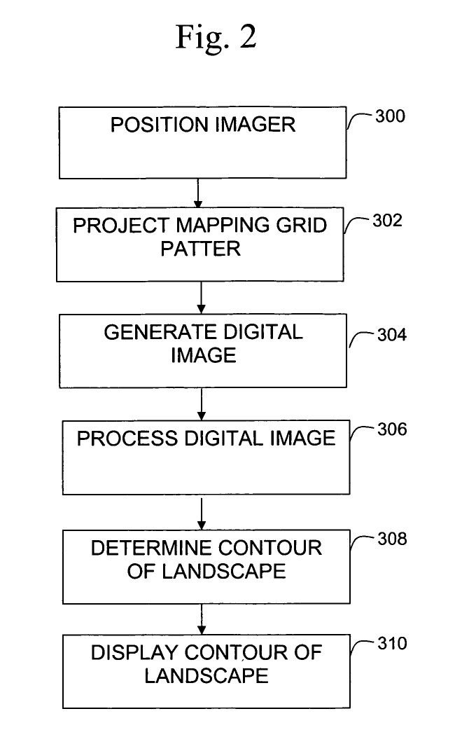

An exemplary flow diagram of an embodiment for determining the contour of a landscape based on distortion in a mapping grid pattern in an image of the landscape is shown in FIG. 2. FIG. 2 is best understood when read in combination with FIG. 1. As shown in FIG. 2, the process begins with step 300, in which a the device is positioned where an image of the landscape is desired to taken. In an embodiment of the present invention, the landscape includes the area between a golf ball and the hole on a putting green. In an embodiment of the present invention, the landscape includes a segment of the area between a golf ball and the hole on a putting green. The device can be positioned approximately 4 to 5 feet above the landscape and a distance of approximate 40 to 50 feet from the landscape. In an embodiment of the present invention, the device is positioned normal to the landscape. In an embodiment of the present invention, the device is handheld with an angle to the landscape that is compensated and known by sensing elements of the light source 120.

In step 302, a mapping grid pattern is projected onto the landscape. In an embodiment of the present invention, the mapping grid pattern is generated by transmitting light through a mask that allows the light to pass in long linear segments in order to achieve the equivalent of a raster scan. The output from the mask is a series of equally spaced lines when viewed on a flat landscape at normal incidence. In an embodiment of the present invention, the mapping grid pattern is generated using software and oscillating optics to perform a raster scan over the landscape. In an embodiment of the present invention, the mapping grip pattern is generated from different perspective views as described.

In step 304, a digital image of the landscape having the mapping grip pattern projected thereon is generated. This includes, but is not limited to, acquiring landscape light or light depicting a landscape and forming an image, providing an analog image signal for extraction of voltage which is proportional to the amount of light which fell on each pixel of a charge-coupled device sensor and converting the voltage to a digital code suitable for further digital signal processing. In an embodiment of the present invention, the color components Red (R), Green (G), and Blue (B) are used. In an embodiment of the present invention, multiple digital images of the landscape having the mapping grip pattern projected thereon are generated.

In step 306, the digital color image is processed to detect the mapping grip pattern in the digital image of the landscape. This includes, but is not limited to, comparing the color space of each pixel in the color digital image with the target color space defined for the mapping grid pattern and storing the location of the pixels whose color space matches the defined target color space for the mapping grid pattern.

In step 308, the contour of the landscape is determined. In an embodiment of the present invention, the angle at which the mapping grid pattern is projected is known. The depths defined by the deformation of the mapping grid pattern are calculated using the Hausler and Heckel approach and normalizing the mapping grid pattern deformation for the angle. The variation in the linearity of the mapping grid pattern, Δx, is used to reconstruct the depth variations of the landscape.

As shown by Hausler and Heckel, if the camera is at normal incidence and the scanning apparatus is at angle A, the depth, z, is given by
Δz=Δx/tan A
Calculations of this type are anticipated in the present invention.

In step 310, an image of the contour of the landscape is reported, such as by display 118. In an embodiment of the invention, the image is presented in real time to the viewer showing the depth pattern of the landscape in the image. This presentation may be by various colors, by outlines of constant depth and alike means commonly used in visual displays.

While specific embodiments of the present invention have been illustrated and described, it will be understood by those having ordinary skill in the art that changes can be made to those embodiments without departing from the spirit and scope of the invention.

What we claim is:

1. A method of determining the location of a landscape, the method comprising:
projecting a mapping grid pattern onto a landscape;
generating a digital image of the landscape with the mapping grid pattern;
determining the contour of the landscape defined by the deformation of the mapping grid pattern in the digital image of the landscape; and
reporting a depth pattern of the landscape in the digital image.

2. The method according to claim 1, wherein the color digital image is generated by one of: a handheld CMOS imager and a handheld CCD imager.

3. The method according to claim 2, further comprising providing a light source for generating the mapping grid pattern.

4. The method according to claim 2, further comprising determining the angle of illumination for the mapping grid pattern.

5. The method according to claim 3, further comprising transmitting light from the light source through a mask that allows the light to pass in long linear segments over the landscape.

6. The method according to claim 3, further comprising transmitting light from the light source in a raster scan pattern over the landscape.

7. The method according to claim 2, wherein the digital image is a black and white image.

8. The method according to claim 2, wherein the digital image is a color image.

9. The method according to claim 2, wherein the light source operates at wavelength near infrared.

10. The method according to claim 1, wherein the landscape is a golf course.

11. The method according to claim 1, wherein determining the contour of the landscape includes reading the digital image for pixels having a target color space.

12. The method according to claim 11, wherein determining the contour of the landscape includes determining the distance to a point on the mapping grid pattern.

13. A system for determining the location of a landscape, comprising:
a light source operable to project a mapping grid pattern onto a landscape; and
an imager operable to:
generate a digital image of the landscape with the mapping grid pattern;
determine the contour of the landscape defined by the deformation of the mapping grid pattern in the digital image of the landscape; and
report a depth pattern of the landscape in the digital image.

14. The system according to claim 13, wherein the imager is one of a CMOS type and a CCD type.

15. The system according to claim 13, wherein the imager is handheld.

16. The system according to claim 13, further comprising a sensor operable to determine the angle of illumination for the mapping grid pattern.

17. The system according to claim 13, wherein the light source transmits light through a mask that allows the light to pass in long linear segments over the landscape.

18. The system according to claim 13, wherein the light source transmits light in a raster scan pattern over the landscape.

19. The system according to claim 13, wherein the digital image is a black and white image.

20. The system according to claim 13, wherein the digital image is a color image.

21. The system according to claim 13, wherein the light source operates at wavelength near infrared.

22. The system according to claim 13, wherein the landscape is a golf course.

23. The system according to claim 13, wherein determining the contour of the landscape includes reading the digital image for pixels having a target color space.

24. The system according to claim 23, wherein determining the contour of the landscape includes determining the distance to a point on the mapping grid pattern.
